(19) United States
(12) Patent Application Publication
(10) Pub. No.: US 2015/0330329 A1
(43) Pub. Date: Nov. 19, 2015

(54) PISTON FOR AN INTERNAL COMBUSTION ENGINE

(71) Applicants: MALHE METAL LEVE S/A, Jundiaí - SP (BR); MAHLE INTERNATIONAL GMBH, Stuttgart (DE)

(72) Inventors: Marcio P. Alves Dos Santos Dias, Mogi Mirim (BR); Rodrigo Scaranello Tavares Leite, Jundiaí (BR); Thais De Moraes Spiandorello, Jundiaí (BR); Estela M. Ricetti Bueno, Jundiaí (BR)

(21) Appl. No.: 14/654,509

(22) PCT Filed: Dec. 19, 2013
(86) PCT No.: PCT/BR2013/000578

§ 371 Date: Jun. 19, 2015

(30) Foreign Application Priority Data
Dec. 20, 2012 (BR) BR 102012032765 1

(51) Int. Cl. F02F 3/26; F02F 3/00

(52) U.S. Cl. CPC F02F 3/26; F02F 3/0015

(57) ABSTRACT

A piston for an internal combustion engine may include a top portion defining a circular outer perimeter. A side portion may extend from the outer perimeter in a direction away from the top portion. The side portion may include at least a first side segment disposed on a side subjected to a greater radial compressive stress in relation to at least a second side segment. The second side segment may be disposed on a side opposite the first side segment. At least two cylindrical portions may each define a radial bore. At least two first structural walls may connect the first side segment with each of the at least two cylindrical portions. At least two second structural walls may connect the second side segment with each of the at least two cylindrical portions.

### CROSS-REFERENCE TO RELATED APPLICATIONS

This application claims priority to Brazilian Patent Application No. 10 2012 032765 1, filed Dec. 20, 2012, and International Patent Application No. PCT/BR2013/000578, filed Dec. 19, 2013, both of which are hereby incorporated by reference in their entirety.

### TECHNICAL FIELD

The present invention relates to a piston for an internal combustion engine, designed particularly for an internal combustion engine that operates on the Otto or Diesel cycle, the constructive geometry of which provides advantages such as increased strength, lower mass and reduced friction, thus optimizing the operation of the internal combustion engine equipped therewith.

### BACKGROUND

A piston for an internal combustion engine such as that used in engines that operate according to the Otto or Diesel cycles, has a generally cylindrical shape having an upper portion or head defining the combustion chamber together with the cylinder head and the engine block, a cylindrical side wall or skirt comprising at least two annular cavities for positioning the piston rings (compression, intermediate, and oil scraper), and a radial boss for positioning the piston pin, which pivotally fixes it to the rod.

In older engines, the pistons feature an almost perfectly cylindrical shape; but the technological improvement and the ever-increasing high power demands, low consumption and pollutant emission limits increasingly restrictive led to a considerable improvement in the shape of this component.

Thus, the most modern engines have pistons whose geometric shape, although obviously being cylindrical to be cooperative with the cylinder inside which it will move a million times, are quite different in elements such as radial bore, skirt, head, grooves and other reinforcing elements.

In essence, designers seek to reduce the size of the side skirt in order to reduce weight and friction, while maintaining the properties of the structural strength of the part. A number of solutions have been proposed recently, some of the most relevant are briefly commented below.

Patent document US 2011/0168124 relates to a piston in which the improvement resides in the specific geometry of the walls that join the two sections of the side skirt (on the sides of the load, called thrust side—TS and on the unloaded side, called anti-thrust side—ATS) with the central portion of the piston, where the bore for positioning the pin is located. According to the teachings of this invention, the walls that connect the side skirt in the TS with the bore are arched, while the walls that effect the connection of the side skirt in the ATS are substantially straight and parallel to each other. As a result of this geometry, the arched side walls in the ATS side have greater elasticity, which is important since they do not suffer as high shear forces and define the stroke of the movement of the piston.

Patent document DE 10145589 relates to a piston for an internal combustion engine the innovation of which, again, is in the connecting walls of the skirt segments with the piston central region, where the bore for positioning the piston pin is located. The connecting walls are convex in the area of the lower peripheral edges and concave or straight in the upper area, just below the ring grooves. The walls of the bore for positioning the piston pin may have a constant or variable thickness.

Patent document JP 11-036978 relates to a piston capable of efficiently distribute the forces on the load side. To this end, the skirt portion on the load side is thicker, and its thickness is greater in the portion adjacent to the ring grooves and gradually decreases.

Patent document JP 2008-286030 relates to a piston of an internal combustion engine capable of resisting the stresses of radial deformation on the portions of the skirt free end. To this end, an internal wall is provided in the form of a plate that anchors both walls joining the two skirt side sections with the bore for positioning the pin, thus ensuring the structural strength of the part.

Finally, patent document JP 2008-309118 relates to a piston ring which has lower wear rate of the grooves and rings. To this end, a cavity is provided adjacent to the rings that receive an insert, which contributes to reduce wear of those elements.

So far, therefore, no piston had been developed that has reached the goals of lower wear, durability and lightness from the innovative geometric changes made by the applicant, after extensive studies and simulations.

### SUMMARY

The present invention relates to a piston of an internal combustion engine, the constructive geometry of which provides advantages such as increased strength, lower mass and reduced friction, thus optimizing the operation of the internal combustion engine equipped therewith.

The objects of the present invention are reached by a piston for an internal combustion engine provided with a substantially circular top portion from which outer circumference protrudes a side portion comprising at least a first segment positioned at the portion of the piston which undergoes greater degree of radial compression and at least a second portion positioned on the opposite portion of the piston, which undergoes a smaller radial compression force. The piston further comprises a substantially cylindrical portion defining a radial bore positioned substantially parallel in the lower portion relative to the top portion, for positioning a piston pin/rod and at least two structural walls making the connection between the first segment of the side portion defining the radial bore and at least two second structural walls making the connection between the second segment of the side portion with the portion which defines the radial bore. The first structural walls are substantially divergent toward the substantially cylindrical portion defining the radial bore and the second structural walls are substantially convergent toward the substantially cylindrical portion defining the radial bore.

### BRIEF DESCRIPTION OF THE DRAWINGS

The present invention will be further described in more details based on one example of realization represented in the drawings. The figures show:

FIG. 1—is a first side view of a possible embodiment of the piston engine object of the present invention.

FIG. 2—is a second side view of the piston illustrated in FIG. 1, lagging by 90° in relation to it.

FIG. 3—is a sectional view of the piston in the position illustrated in FIG. 1.

FIG. 4—is a sectional view of the piston in the position illustrated in FIG. 2.

FIG. 5—is a bottom perspective view of the piston illustrated in FIGS. 1 to 4.

FIG. 6—is a bottom view of the piston illustrated in FIGS. 1 to 5.

FIG. 7—is a graph comparing the reduction in mass/weight.

### DETAILED DESCRIPTION

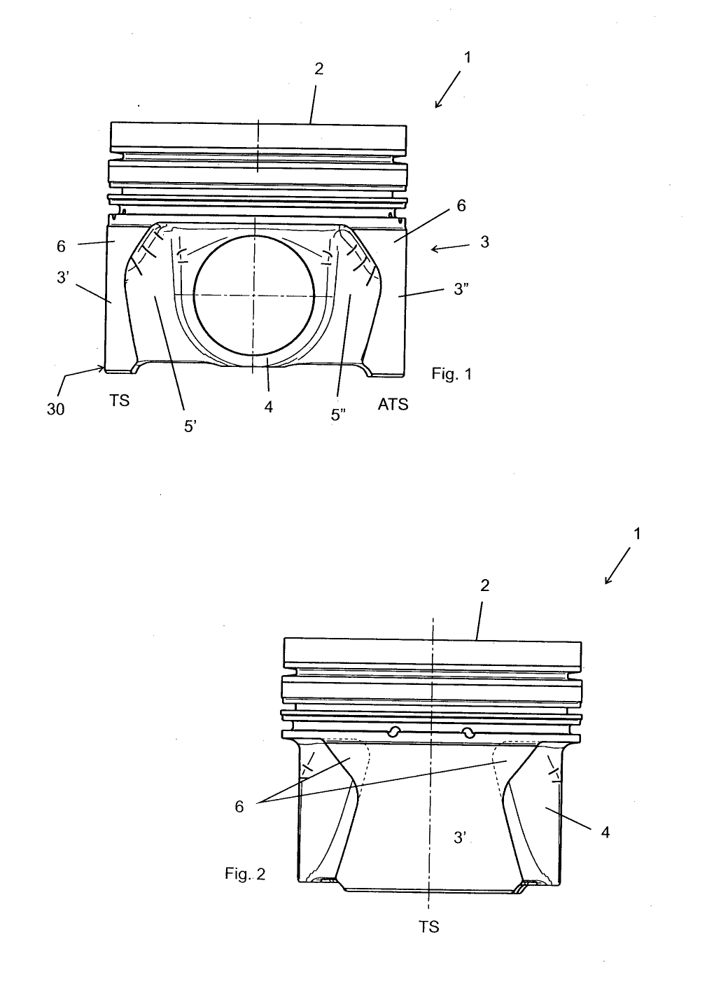

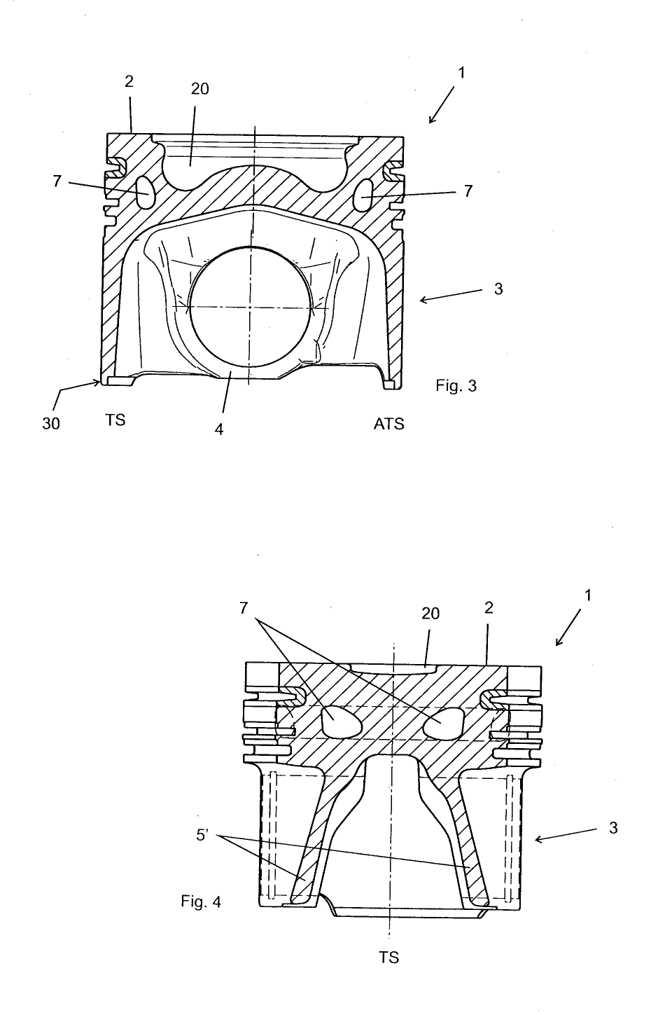

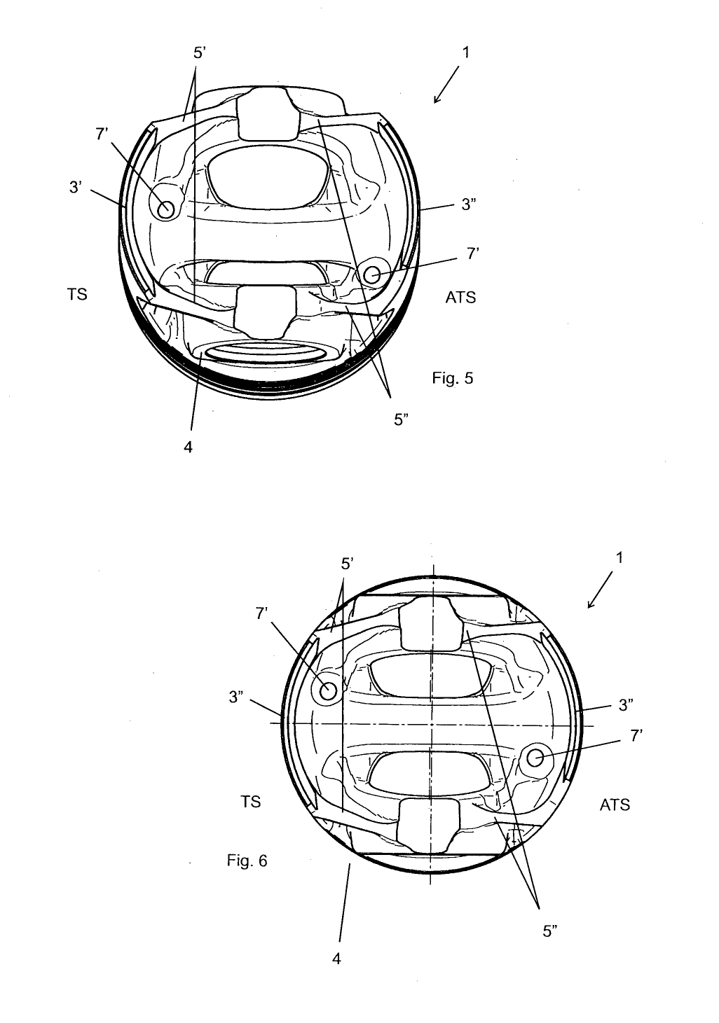

According to a preferred embodiment and, as can be seen from FIG. 1, the present invention relates to a piston for an internal combustion engine 1, particularly designed for use in an engine which operates according to the Otto and Diesel cycles. In a preferred embodiment, the piston is designed for use in Diesel engines, as is the case of the embodiment illustrated in the figures; but conceptually nothing prevents the piston to be used in an Otto cycle engine, such as a gas engine or even in other uses, such as in a two-stroke engine or a fluid compressor.

As the vast majority of currently known pistons, piston 1, object of the present invention, is provided with a top portion 2 (usually called “upper” portion, being the one that comes into contact with the air-fuel mixture) substantially circular from an outer circumference of which protrudes a side portion 3 comprising at least two (but in practice, three or four) annular cavities for positioning the piston rings which are split into the compression rings, intermediate or second groove rings and oil-film control or scraper rings. Because it is not relevant in defining the scope of protection of the present piston, the shape, number and positioning of the annular cavities may vary freely.

The side portion of piston 1 can be continuous or segmented and, in a preferable but not mandatory manner, comprises at least a first segment 3′ positioned on the portion of the piston suffers the greatest stresses of radial compression, called TS, thrust side, (arising from the explosion of the fuel-air mixture, which moves the piston against the inner surface of the jacket (not shown) in the direction of the crankshaft (not shown), causing a change in the angle of the connecting rod which ultimately generates a non-negligible component of radial force). It is further provided at least one second segment 3″ positioned in the opposite region of the piston, lagging 180°, and which does not undergo radial compression stresses in that magnitude, called ATS (anti-thrust side).

Because of the difference in radial force they are subjected to, the first side segment 3″ has an average thickness greater than the average thickness of the second side segment 3″. If measured at points corresponding to each of the segments, the thickness of the first segment 3′ will always be greater than the thickness of the second segment 3″.

On the other hand, it is the second side segment 3″ the one responsible for guiding the movement of piston inside the cylinder, especially in the compression and exhaust strokes, which has the width (arc) higher than the first side segment 3′. In other words, the width of the first side segment 3′ is smaller than the width of the second side segment 3″.

In a preferred but not mandatory manner, each of the first and second side segments 3′, 3″ has a free end 30, opposite the top portion 2 of which they protrude from, the thickness of the at least first and second side segments 3′, 3″ decreasing from top portion 2 toward free end 30.

Piston 1 further comprises a substantially cylindrical portion defining a radial bore 4 positioned substantially parallel, and in the lower portion relative to the top portion 2, for positioning a piston pin/rod, which will allow the angular movement of the rod relative to the piston.

There are also side walls 5′, 5″ joining the first and second side segments 3′, 3″ with the substantially cylindrical portion defining the radial bore 4, with the primary function of providing shape structure and mechanical strength to piston 1. Side walls exist in most modern pistons, but the configuration they assume in piston 1, object of the present invention, is completely novel and innovative, providing it with properties of strength and lightness.

In essence, whatever its specific configuration, piston 1, object of the present invention, comprises at least the first two structural walls 5′ which perform the connection between the first segment of the side portion 3′ with the portion that defines the radial bore 4, and at least two second structural walls 5″ making the connection between the second segment of side portion 3″ with the portion defining the radial hole 4.

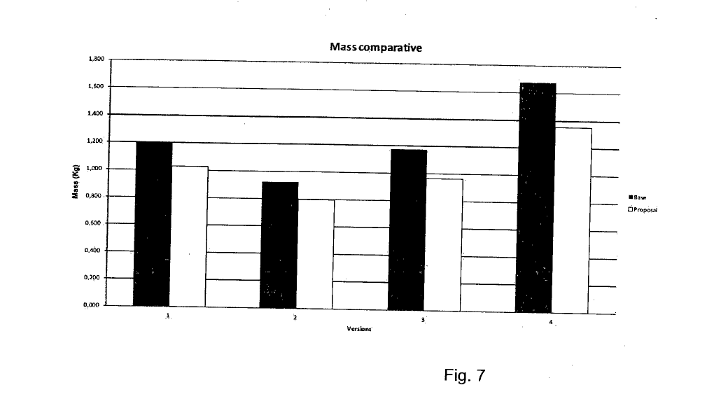

The first structural walls 5′ are substantially divergent toward the substantially cylindrical portion defining the radial bore 4 and the second structural walls 5″ are substantially convergent toward the substantially cylindrical portion defining the radial bore 4. Walls 5′, 5″ can be seen, particularly, in FIGS. 5 and 6.

In addition to the fact that the first two structural walls 5′ are divergent and second walls 5″ are convergent toward the substantially cylindrical portion which defines the radial bore 4, they are essentially and substantially straight at the free end 30. The wall 5′ has a variable and increasing thickness towards 3′. The outer surface of the wall 5′ can be parallel or divergent with respect to bore 4 and the inner wall surface 5′ is necessarily divergent with respect to bore 4. Wall 5″ has a constant thickness. Regarding the upper portion 2 (top), walls 5′, 5″ are convergent.

Its inclination, combined with the fact that they are substantially straight and respectively convergent/divergent causes the first and second structural walls 5′, 5″ are very important in the improved structural behavior of piston 1, object of the present invention over those currently known.

Optionally, the piston comprises at least one reinforcing element 6 for increasing strength in the cooperation region between walls 5′, 5″ and top portion 2. In a preferred manner, four reinforcing elements (which may be of different dimensions/sizes) are provided, which increase the rigidity of the piston and helps to prevent the peripheral portion from “twisting” laterally on the aforementioned radial bore, especially when the engine equipped with piston 1 has high thermo-mechanical loading, as in the case of a piston designed for a Diesel engine. The reinforcing elements can be seen in FIG. 1.

Still optionally, a cavity 7 is provided adjacent to the cooperation region between the portion which defines the radial bore 4 and the top portion 2, the cavity having at least one access window 7′. This cavity is used to allow for an oil flow in the inner region of the piston, which is important to reduce the temperature of the top portion and vicinity.

Cavity 7 being provided, one can anticipate a branch in the engine lubrication circuit to create an oil flow there, thus removing the heat.

Anyway, and even to be an optional characteristic, the shape of the cavity and the shape and amount(s) of the respective access window(s) 7′ can vary freely.

Finally, another option, but not a limiting characteristic of piston 1, object of the present invention, is the provision of a cavity 20 in the top portion 2 that defines the engine combustion chamber when the piston is positioned inside the cylinder.

Due to the above characteristics, current piston 1 has a number of advantages over the currently existing pistons, such as increased strength (due to the optimized geometry, with particular regard to the first and second structural walls 5′, 5″), mass reduction (due to the size reduction and the thickness of the various parts of piston 1), friction reduction.

The present invention allows, through its modified geometry, to achieve greater mass reductions through thickness optimizations in regions where conventional geometry does not permit it, which is achieved by definition of the manufacturing process or commitment of the changed region. The present invention makes it possible to achieve mass reductions above 12%, without compromising its application ability.

Evidently, piston 1 can be made of any necessary or desirable metallic or non-metallic material.

After one example of a preferred embodiment has been described, it should be understood that the scope of the present invention encompasses other possible embodiments and is limited only by the content of the appended claims, which include their possible equivalents.

1. A piston for an internal combustion engine, comprising: provided with a top portion defining a circular outer perimeter and a side portion extending from the outer perimeter in a direction away from the top portion, the side portion positioned away from a region of combustion in relation to the top portion, the side portion including at least a first side segment disposed on a side subjected to a greater radial compressive stress in relation to at least a second side segment, the second side segment disposed opposite the first side segment on a side subjected to a lower stress radial compression in relation to at least the first side segment, and at least two cylindrical portions each defining a radial bore disposed substantially parallel to one another, in a lower portion of the side portion relative to the top portion for receiving a pin, wherein at least two first structural walls connect the first side segment with each of the at least two cylindrical portions and at least two second structural walls connect the second side segment with each of the at least two cylindrical portions, and wherein at least one of:
the at least two first structural walls diverge with respect to each other in a direction towards the respective radial bores; and
the at least two second structural walls converge with respect to each other in a direction towards the respective radial bores.

2. The piston according to claim 1, wherein each of the first side segment and second side segments include a free end opposite the top portion, and wherein a thickness of at least one of the first side segment and the second side segment decreases from the top portion towards the respective free ends.

3. The piston according to claim 1, wherein each of the first side segment and the second side segment define a thickness extending between the top portion and a free end opposite the top portion, and wherein the first side segment has an average thickness greater than an average thickness of the second side segment.

4. The piston according to claim 1, wherein the first side segment defines a width in a circumferential direction less than a width of the second side segment.

5. The piston according to claim 1, further comprising at least one reinforcing element for increasing the strength of the side portion, wherein the at least one reinforcing element is disposed in a cooperation region extending between (i) at least one of the at least two first structural walls and the at least two second structural walls and (ii) the top portion.

6. The piston according to claim 1, further comprising at least one cavity adjacent to a cooperation region between the at least two cylindrical portions and the top portion, wherein the at least one cavity includes at least one access window for communicating a fluid into an inner region of the piston.

7. The piston according to claim 1, wherein the top portion includes at least one cavity defining an engine combustion chamber when positioned inside an engine cylinder.

8. The piston according to claim 1, wherein a thickness of the first side segment is greater than a thickness of the second side segment when measured at corresponding points along the side portion.

9. The piston according to claim 8, wherein the thickness of at least one of the first side segment and the second side segment decreases in a direction away from the top potion.

10. The piston according to claim 1, wherein the at least two first structural walls each define a thickness increasing in a direction from the respective radial bores towards the first side segment.

11. The piston according to claim 10, wherein the at least two second side walls each have a constant thickness.

12. The piston according to claim 10, wherein a thickness of the first side segment and a thickness of the second side segment decrease in a direction away from the top potion.

13. The piston according to claim 2, wherein an average thickness of first side segment is greater than an average thickness of the second side segment.

14. The piston according to claim 13, wherein the first side segment defines a width in a circumferential direction less than a width of the second side segment.

15. The piston according to claim 2, further comprising at least two reinforcing elements configured to increase the strength of the side portion, wherein one reinforcing element is disposed between the at least two first structural walls and the top portion, and another reinforcing element is disposed between the at least two second structural walls and the top portion.

16. The piston according to claim 2, wherein the first side segment defines a width in a circumferential direction less than a width of the second side segment.

17. The piston according to claim 16, further comprising at least one reinforcing element configured to increase the strength of the side portion, wherein the at least one reinforcing element is disposed in a cooperation region defined between at least one of (i) the at least two first structural walls and the at least two second structural walls and (ii) the top portion.

18. The piston according to claim 5, further comprising at least one cavity disposed between the cooperation region and the top portion, wherein the at least one cavity includes at least one access window for communication a fluid into an inner region of the piston.

19. The piston according to claim 18, wherein the top portion defines a combustion chamber open axially towards the region of combustion.

20. A piston for an internal combustion engine, comprising:
a top portion defining a circular outer perimeter;
a side portion extending from the outer perimeter in a direction away from the top portion, the side portion disposed away from a region of combustion in relation to the top portion, the side portion including:
a first side segment disposed on a thrust side of the side portion;
a second side segment disposed opposite the first side segment on an anti-thrust side of the side portion, wherein the first side segment is subjected to a greater radial compressive stress in relation to the second side segment;
at least two cylindrical portions each defining a radial bore, the two cylindrical portions disposed opposite one another between the first side segment and the second side segment;
at least two first structural walls connecting the first side segment with each of the two cylindrical portions; and
at least two second structural walls connecting the second side segment with each of the two cylindrical portions;
wherein at least one of (i) the at least two first structural walls diverge with respect to one another in a direction towards the respective radial bores and (ii) the at least two second structural walls converge with respect to one another in a direction towards the respective radial bores; and
wherein a thickness of at least one of the first side segment and the second side segment decreases in the direction away from the top portion, and wherein the first side segment defines a width in a circumferential direction less than a width of the second side segment.
